(19) United States
(12) Patent Application Publication
(10) Pub. No.: US 2024/0199932 A1
(43) Pub. Date: Jun. 20, 2024

(54) ABRASIVE ZIRCONIUM CORUNDUM GRAINS HAVING A HIGH SIO2 CONTENT

(71) Applicant: IMERTECH SAS, Paris (FR)

(72) Inventors: Reiner KUNZ, Laufenburg (DE); Thomas FUCHS, Murg (DE); Andreas HOTTINGER, Rickenbach-Hütten (DE)

(21) Appl. No.: 18/003,233

(22) PCT Filed: Jun. 24, 2021
(86) PCT No.: PCT/EP2021/067308

§ 371 Date: Dec. 23, 2022

(30) Foreign Application Priority Data
Jun. 25, 2020 (DE) 10 2020 116 845.4

(51) Int. Cl. C09K 3/14

(52) U.S. Cl. CPC C09K 3/1427

(57) ABSTRACT

The present invention relates to abrasive zirconium corundum grains based on Al₂O₃ and ZrO₂ that have been melted in an electrical arc furnace and have a content of—Al₂O₃ between 52% and 62% by weight,—ZrO₂ (+HfO₂) between 35.0% and 45.0% by weight, where a total of at least 80% by weight of the ZrO₂, based on the total content of ZrO₂, is in the tetragonal and/or cubic high-temperature modification,—Si compounds of more than 0.8% by weight, expressed as SiO₂,—carbon between 0.03% and 0.5% by weight,—additives between 0.5% and 10% by weight and—raw material-related impurities of less than 3% by weight, where the raw material base for the abrasive grains comprises aluminum oxide, baddeleyite and zircon sand.

### TECHNICAL FIELD

The present invention relates to abrasive grains based on Al₂O₃ and ZrO₂ that have been melted in an electrical arc furnace with a content of Al₂O₃ between 52% and 62% by weight and a ZrO₂ (+HfO₂) proportion of between 35% and 45% by weight, the raw material base for the abrasive grains comprising aluminum oxide, baddeleyite and zircon sand. According to the definition, the term baddeleyite includes all natural and artificial ZrO₂ concentrates with a content of ZrO₂ of at least 96% by weight.

### PRIOR ART

Abrasive grains based on zirconium corundum have been known for many years and are used successfully in bonded or coated abrasives, in particular for machining high-alloy steels. In addition to the microcrystalline structure, the proportions of high-temperature modifications of the zirconium oxide have a major influence on the performance of the abrasive grains. This applies in particular to the so-called eutectic zirconium corundum, which, in addition to aluminum oxide and other oxides that are present as impurities or deliberately introduced additives, preferably contains 35 to 50 percent by weight zirconium oxide. In the past, therefore, attempts have repeatedly been made to improve the performance of zirconium corundum by refining the structure and/or increasing the proportion of high-temperature modifications. While the structure can be improved by efficiently and quickly quenching the liquid melt, high proportions of high-temperature modifications can be achieved primarily through the targeted use of stabilizers, with titanium oxide and/or yttrium oxide often being used as stabilizers for the high-temperature modifications of zirconium oxide.

Zirconium oxide exists in three different modifications. The monoclinic modification, which is stable at room temperature, converts at temperatures between approx. 800 and 1200° C. into the tetragonal modification, which is stable up to approx. 2300° C. and then changes into the cubic modification. The above temperatures apply to pure zirconium oxide. The temperatures shift in mixtures or doped materials. The reversible phase transformations are associated with volume changes, with the tetragonal high-temperature modification having the smallest volume. The transition from the tetragonal to the monoclinic modification, which has the largest volume, is associated with a volume increase of 4.5%. The person skilled in the art explains the positive influence of the high-temperature modification in the abrasive grain by the fact that during the grinding process a tetragonal to monoclinic phase transformation takes place due to the heat development that takes place, wherein the increase in volume results in stress with the formation of microcracks favoring breaking off of small sections, whereby new cutting edges are formed. This process is often referred to as self-sharpening.

U.S. Pat. No. 5,525,135 A (EP 0 595 081 B1) describes an abrasive grain based on zirconium corundum in which more than 90 percent by weight of the zirconium oxide is in the tetragonal high-temperature modification. In this case, the high-temperature phase is stabilized by adding titanium oxide in the presence of carbon as a reducing agent and then rapidly quenching the melt. It is assumed that the resulting reduced titanium compounds in the form of suboxides stabilize the high-temperature phases of the zirconium oxide.

The subject matter of U.S. Pat. No. 7,122,064 B2 (EP 1 341 866 B1) relates to abrasive grains based on zirconium corundum, in which the high-temperature phases of the zirconium oxide are likewise stabilized with titanium compounds in the reduced form. The abrasive grains described in the document also have a silicon compound content of between 0.2 and 0.7 percent by weight, expressed as SiO₂. Although the stabilizing effect of the reduced titanium compounds is significantly reduced by the addition of SiO₂, the viscosity of the melt is also greatly reduced at the same time, making it easier to quench the melt, with the liquid material being poured in between metal plates. The rapid quenching has a positive effect on the structure of the finished abrasive grain and in this way a particularly fine-crystalline and homogeneous structure can be achieved, which is another important criterion for product quality in addition to the high proportion of high-temperature modifications of the zirconium oxide.

U.S. Pat. No. 4,457,767 A describes an abrasive zirconium corundum grain containing between 0.1 and 2 percent by weight of yttrium oxide, the yttrium oxide being used as a stabilizer for the high-temperature modification of the zirconium oxide. It is known that the stabilizing effect of Y₂O₃ for the high-temperature phases of zirconium oxide is more pronounced than that of reduced TiO₂, so that comparatively less Y₂O₃ has to be used in order to obtain comparable proportions of high-temperature phases.

Abrasive grains based on zirconium corundum are still among the most important conventional abrasive grains for processing steel, so that great efforts are being made worldwide to further improve the performance of these abrasive grains. However, a further increase in the proportion of high-temperature modifications alone does not seem to bring about an adequate increase in performance. WO 2011/141037 A1 describes grinding tests with abrasive zirconium corundum grains, some of which have exclusively high-temperature modifications of the zirconium oxide, but compared to abrasive grains with approx. 90 percent by weight of high-temperature modifications, based on the total proportion of zirconium oxide, no improved grinding performance are apparent. In contrast, WO 2011/141037 A1 consistently differentiates between the tetragonal and cubic high-temperature phase for the first time, with an optimization of the grinding performance being described if more than 20% by weight of the zirconium oxide is present in the cubic high-temperature phase and more than 50% by weight of the zirconium oxide is present in the tetragonal high-temperature phase, each based on the total proportion of zirconium oxide, which is achieved by a combined use of Y₂O₃ and TiO₂ as stabilizers in the presence of a little SiO₂ as a flux.

US 2012/0186161 A1 describes an abrasive grain based on molten eutectic zirconium corundum, which has a proportion of tetragonal zirconium oxide phase of 60 to 90 percent by weight, based on the total proportion of zirconium oxide. The phase distribution with relatively low proportions of tetragonal phase is achieved by a chemical composition using yttrium oxide and titanium oxide in the presence of SiO₂ with a ratio of Y₂O₃/SiO₂ between 0.8 and 2.0 as stabilizers for the high-temperature phase. Due to its lower toughness, the product is said to be particularly well suited for machining alloyed steels with low contact pressure. The self-sharpening of the abrasive grain takes place under relatively mild conditions, so that thermal damage to the workpiece can be avoided while at the same time high removal rates are achieved.

Generally, the content of SiO₂ of abrasive zirconium corundum grains is always viewed critically, since the SiO₂ limits the stabilizing effect of the additives or hinders the stabilization of the high-temperature modifications of the ZrO₂. All high-performance eutectic abrasive zirconium corundum grains described in the prior art therefore have a content of SiO₂ of less than 0.8% by weight. As a result, relatively pure raw materials based on Al₂O₃ and ZrO₂ have always been used in the past in order to avoid excessive SiO₂ contamination. Primarily, pure aluminum oxide and baddeleyite were used, wherein, in addition to the stabilizing additives such as TiO₂ and Y₂O₃, quartz sand or zircon sand as a source for the small amounts of SiO₂ required to improve the flowability of the liquid melt, were used. Recently, since resources of natural baddeleyite are limited, artificially produced ZrO₂ concentrates have also been used.

### DESCRIPTION OF THE INVENTION

Faced with the task of further optimizing the production of eutectic abrasive zirconium corundum grains, attempts were also made to use less expensive raw materials. For example, series of tests were run in which, in addition to baddeleyite, zircon sand, which up to now was usually only used as a source of SiO₂ in the production of zirconium corundum, was used directly as a raw material for the ZrO₂ in zirconium corundum. As expected, the proportion of SiO₂ in the product increased, which in most cases also led to the product deterioration that was also to be expected. Surprisingly, however, the amount of zircon sand could be tripled without deteriorating the product quality when stabilizing with a combination of TiO₂ and Y₂O₃. Since high proportions of SiO₂ were previously synonymous with a deterioration in the product for those skilled in the art, the tests were repeated frequently and varied accordingly with changing raw material composition for the melt and using quartz as the source of SiO₂ in addition to zircon sand. It was shown that when the ZrO₂ was stabilized with a mixture of TiO₂ and Y₂O₃ in a ratio of 2:1 to 4:1 with the increased use of zircon sand as a raw material source, the SiO₂ proportions in the product increased, however, even with a proportion of more than 1% by weight of SiO₂ in the product, no negative influence on the product quality was found. In contrast, comparative tests in which the SiO₂ proportion was increased by adding quartz sand, while standard formulations were used as raw materials, always showed a significant deterioration in product quality as soon as the SiO₂ proportion in the product was more than 0.6% by weight. Even when the high-temperature modification of zirconium oxide was stabilized with TiO₂ or Y₂O₃ alone or in a ratio of TiO₂ to Y₂O₃ other than 2:1 to 4:1, product deterioration was always found.

The subject matter of the present invention thus relates to abrasive grains based on Al₂O₃ and ZrO₂ that have been melted in an electrical arc furnace and have a content of Al₂O₃ between 52% and 62% by weight and ZrO₂ (+HfO₂) between 35.0% and 45.0% by weight. In the abrasive grains a total of at least 80% by weight of the ZrO₂, based on the total content of ZrO₂, is in the tetragonal and/or cubic high-temperature modification. Since the abrasive grains are produced under reducing conditions, with carbon being used as the reducing agent, the abrasive grains contain between 0.03 and 0.5% by weight of carbon. The high-temperature modifications of zirconium oxide are stabilized by adding rutile (TiO₂) and yttrium oxide so that the abrasive grains have a reduced titanium oxide content, expressed as TiO₂, between 1.0% and 4.0% by weight and Y₂O₃ between 0.2 and 1.5% by weight, wherein the ratio of TiO₂ to Y₂O₃ is 2:1 to 6:1. In addition, the abrasive grains have less than 3% by weight of raw material-related impurities. The proportion of Si compounds in the abrasive grains according to the invention, expressed as SiO₂, is more than 0.8% by weight, preferably more than 1.0% by weight. In an advantageous embodiment of the present invention, the content of SiO₂ is 1.1% to 1.5% by weight. The raw material basis for the abrasive grains comprises aluminum oxide, baddeleyite and zircon sand, the ratio of baddeleyite to zircon sand being 3:1 to 1:2, preferably 1.5:1 to 1:1.5.

Grinding tests are usually carried out to assess the quality of abrasive grains. These grinding tests are relatively complex and time-consuming. It is therefore common in the abrasives industry to assess the quality of abrasive grains in advance based on mechanical properties, which are more easily accessible and serve as indicators for later behavior in the grinding test. In addition to the structure already mentioned above and the proportions of high-temperature modifications, micrograin disintegration in particular during grinding in a ball mill is used to assess the quality of abrasive grains.

### Micrograin Disintegration (MKZ)

To measure microparticle disintegration, 10 g of corundum (grain size 36) are ground in a ball mill filled with 12 steel balls (diameter 15 mm, weight 330-332 g) at 188 revolutions per minute for a specific period of time. The ground abrasive grains are then sieved for 5 minutes through a 250 μm sieve in a (Haver Böcker EML 200 sieve) and the fines are weighed.

The MKZ value is calculated as follows:

MKZ(%)=(Sieve passage 250 μm/total weight)×100

In the present case, the proportion of high-temperature phases of the zirconium oxide was determined as a further criterion for the product quality, although no distinction was made between the cubic and tetragonal phase, rather only a T factor encompassing both phases was determined.

### T Factor

The quantitative measurement of the proportion of high-temperature modifications of ZrO₂, based on the total proportion of ZrO₂, is carried out using an X-ray diffractometer in a 2-theta measuring range between 27.5° and 32.5°. The proportions of high-temperature phases (T factor) are determined according to the equation:

$$T ( \% by weight ) = \frac{2 t \times 100}{2 t + {m}_{1} + {m}_{2}}$$

t=intensity of the tetragonal peak at 2 theta of 30.3°
m₁=intensity of monoclinic peak at 2 theta of 28.3°
m₂=intensity of monoclinic peak at 2 theta of 31.5°

### DESCRIPTION OF PREFERRED EMBODIMENTS

The invention is explained in detail below, without limitation, using a few selected examples. These examples are used to demonstrate some general relationships in the melting system Al₂O₃/ZrO₂ with the stabilizers TiO₂ and Y₂O₃ in the presence of SiO₂ as a flux, which provide the person skilled in the art with clues as to how to optimize the production of abrasive grains on the basis of eutectic zirconium corundum that has been melted in an electrical arc furnace, without the products deteriorating.

The samples for the investigations were produced in a conventional manner by melting a mixture of alumina, baddeleyite concentrate, zircon sand and petroleum coke with the addition of rutile sand and/or Y₂O₃ in an electrical arc furnace. After the entire raw material mixture had melted completely, the melt was poured according to EP 0 593 977 into a gap of approx. 3 to 5 mm between metal plates. After complete cooling, the zirconium corundum sheets quenched in this way were crushed in the usual manner using jaw crushers, roller crushers, roller mills or cone crushers and sieved to give the desired grain size fractions. In comparative Example H, quartz was used as the SiO₂ source instead of zircon sand.

The raw materials are listed first in Table 1 below, with the proportion of coal, which essentially burns in the melt, not being included in the sum of the raw material mixture. In the product composition, the remainder to 100% is the value for Al₂O₃. In addition to the MKZ values and the T values, the proportion of Zr sand in percent in the raw material mixture, which is crucial for the desired product optimization, are listed again separately.

TABLE 1

| Example | | A | B | C | D | E | f | G | H |
|---|---|---|---|---|---|---|---|---|---|
| Al₂O₃ | kg | 350 | 350 | 350 | 350 | 350 | 350 | 350 | 350 |
| baddeleyite | | 230 | 230 | 190 | 190 | 150 | 230 | 190 | 250 |
| Zr sand | | 50 | 50 | 100 | 100 | 150 | 50 | 100 | — |
| rutile | | 20 | 20 | 20 | 20 | 20 | — | — | 20 |
| Y₂O₃ | | — | 6 | — | 6 | 6 | 6 | 6 | 6 |
| carbon | | 20 | 20 | 20 | 20 | 20 | 20 | 20 | 20 |
| quartz | | — | — | — | — | — | — | — | 30 |
| total | | 650 | 656 | 660 | 666 | 676 | 636 | 646 | 656 |
| Al₂O₃ | % | rest | rest | rest | rest | rest | rest | rest | rest |
| ZrO₂ | | 41.5 | 41.1 | 40.8 | 40.5 | 39.8 | 42.4 | 41.8 | 39.5 |
| TiO₂ | | 3.0 | 3.2 | 3.1 | 2.9 | 3.2 | — | — | 2.9 |
| SiO₂ | | 0.4 | 0.37 | 1.1 | 1.1 | 1.3 | 0.3 | 0.72 | 1.2 |
| Y₂O₃ | | — | 0.9 | — | 0.82 | 0.9 | 1.0 | 0.98 | 0.80 |
| MKZ value | % | 5.0 | 4.4 | 7.0 | 4.6 | 5.2 | 5.9 | 6.0 | 8.4 |
| T factor | % | 94 | 98 | 90 | 96 | 97 | 96 | 95 | 88 |
| Zr sand | % | 8 | 8 | 15 | 15 | 22 | 8 | 15 | 0 |

Examples A and B are comparative examples and correspond to commercially available products, the zirconium oxide in comparative Example A being stabilized only with reduced titanium oxide, while in comparative Example B the high-temperature modifications were stabilized with a combination of titanium oxide and yttrium oxide. The different stabilization is noticeable in comparative Example B primarily in the increased T value. At the same time, compared to comparative Example A, an improved MKZ value is apparent, which means that improved grinding performance can be expected, which was then confirmed in the subsequent grinding tests. For both comparative examples, the usual amounts of zircon sand were used as the SiO₂ source, at 8% by weight, resulting in an SiO₂ content of 0.4% and 0.37% by weight, respectively, in the products.

Example C corresponds to Example A in terms of stabilization, but the proportion of zircon sand has been doubled, while the proportion of baddeleyite concentrate has been correspondingly reduced in order to keep the overall zirconium oxide content in the product at a constant level. Doubling the zircon sand increases the SiO₂ proportion in the product to 1.1% by weight. At 6.9, the MKZ value is in the range of the value for product A. Like Example B, Example D is stabilized with a combination of TiO₂ and Y₂O₃, with the proportion of zircon sand being increased as in Example C. A corresponding SiO₂ proportion of 1.1% by weight was measured in product D. At 4.6, the MKZ value is surprisingly low and an attractive grinding performance can be expected.

A further increase in the proportion of zircon sand in the raw material mixture was implemented in Example E, with baddeleyite and zircon sand being used in a ratio of 1:1. In order to keep the zirconium oxide content in product E at a comparable level, the baddeleyite content was reduced accordingly. The raw material mixture thus contained a total of 22% by weight of zircon sand. Product E had an SiO₂ proportion of 1.3% by weight and had an MKZ value of 5.0.

Example F is another comparative example with a conventional proportion of zircon sand, the high-temperature modifications of the zirconium oxide being stabilized solely with Y₂O₃. The T factor and the MKZ value are comparable to the values found for product A, which can possibly be seen as an indication that the type of stabilizer plays a minor role when only one type of stabilizer is used. Example G, in which the proportion of zircon sand has now been doubled compared to Example F, shows a deterioration in the key figures, which, however, is relatively small compared to the individual stabilization with TiO₂ in Example C. Comparative Example H corresponds to Examples B, D and E in terms of stabilization, however, only quartz was used as the SiO₂ source. The proportion of zirconium oxide in the product was adjusted by increasing the amount of baddeleyite used. In the case of product H, the negative influence of the high proportion of SiO₂ on the product quality can be clearly seen in the key figures (MKZ value, T factor), which then also manifests itself in the grinding tests. In addition, a significantly increased porosity with a high proportion of micro and macropores was found in polished sections of product H in the scanning electron microscope (SEM), which can be seen as another reason for the poor results in the grinding tests on polished sections.

### Grinding Test 1 (Cutting Disk Test)

Cutting disks of specification R-T1 180×3×22.23 were chosen for the cutting disk test. For this purpose, a pressing mixture consisting of 75% by weight zirconium corundum, 5% by weight liquid resin and 12% by weight powdered resin from HEXION specialty chemicals GmbH, 4% by weight pyrite and 4% by weight cryolite. To produce the disks, 160 g of the press mixture was molded onto commercially available fabric and pressed at 200 bar and then cured according to the resin manufacturer's instructions.

For the cutting test itself, round rods made of stainless steel (CrNi) with a diameter of 20 mm were used. The cutting operations were carried out with a disk speed of 8,000 revolutions per minute with a cutting time of 3 seconds. After 20 cuts, disk loss was determined from the decrease in diameter of the disks. The G ratio was then determined from the quotient of material removal and disk loss.

Cutting disks: 180×3×22.23 mm

### Grain: F24 (40%); F30 (40%); F36 (30%)

Material: Cr—Ni stainless steel rods, diameter 20 mm
Grinding machine: Fein WSB 25-180 X, speed 8000 rpm

### Test Method:

To condition the system, 3 cuts were made beforehand. The starting diameter of the disks was then determined. After 40 additional cuts, the final diameter of the disks was determined. The performance of the grains was determined by determining the decrease in disk diameter after the 40 cuts.

3 disks of each grain were produced and tested.

Table 2 below shows the average values for each of the 3 cutting disks.

TABLE 2

| Test grain, | Diameter | Diameter | Diameter | |
|---|---|---|---|---|
| according | start | end | difference | Performance |
| to Example | (mm) | (mm) | (mm) | (%) |
| A | 179.4 | 175.2 | 4.2 | 100% |
| B | 179.8 | 176.3 | 3.5 | 120% |
| C | 179.3 | 174.7 | 4.6 | 91% |
| D | 179.5 | 176.0 | 3.5 | 120% |
| E | 179.4 | 175.8 | 3.6 | 117% |
| f | 179.4 | 175.1 | 4.3 | 98% |
| G | 179.2 | 174.9 | 4.4 | 96% |
| H | 179.0 | 173.9 | 5.1 | 82% |

### Grinding Test 2 (Cutting Disk Test)

Commercially available synthetic resin-bonded and glass fiber-reinforced cutting disks were produced and tested with the grains produced (Examples A to H according to Table 1):

Cutting disks: 125×1.2×22.23 mm

### Grain: F46 (60%); F60 (40%)

Material: stainless steel rods, diameter 20 mm
Grinding machine: Fein WS 14 1, 2 kW, speed approx. 10,000 rpm

### Test Method:

To condition the system, 3 cuts were made beforehand. The starting diameter of the disks was then determined. After 25 additional cuts, the final diameter of the discs was determined.

The performance of the grains was determined by determining the decrease in disk diameter after the 25 cuts.

3 disks of each grain were produced and tested.

Table 3 below shows the average values of the 3 measurements

TABLE 3

| Test grain, | Diameter | Diameter | Diameter | |
|---|---|---|---|---|
| according | start | end | difference | Performance |
| to Example | (mm) | (mm) | (mm) | (%) |
| A | 124.0 | 112.9 | 11.1 | 100% |
| B | 124.1 | 114.8 | 9.3 | 119% |
| C | 123.9 | 111.8 | 12.1 | 92% |
| D | 124.2 | 114.9 | 9.3 | 119% |
| E | 124.3 | 114.9 | 9.4 | 118% |
| f | 124.2 | 113.2 | 11.0 | 101% |
| G | 123.9 | 112.3 | 11.6 | 96% |
| H | 123.6 | 110.4 | 13.2 | 84% |

### Grinding Test 3 (Abrasive Belt)

Commercially available abrasive belts were produced on an impregnated polyester/cotton blend fabric by means of electrostatic scattering with the grains produced (Examples A to H according to Table 1).

Abrasive belt: length 2000 mm width 50 mm
Grain size: NP 40
Grain coating: see below

The abrasive belts were used to grind the face of stainless steel rods.

Workpiece: stainless steel rod (CrNi steel) diameter 20 mm
Contact disk: diameter 250 mm, hardness 90 shore
Contact force: 68.7 Newton
Cutting speed: 30 m/s
Grinding cycle: 10 seconds grinding phase−20 seconds cooling phase

The performance of the grains in the belts was determined by the total removal rate after 24 grinding cycles with a total grinding time of 12 min. The results are summarized in Table 4 below.

TABLE 4

| Test grain, | Spreading | Material | |
|---|---|---|---|
| according | density | removal | Performance |
| to Example | (g/m²) | (g) | (%) |
| A | 593 | 582.3 | 100% |
| B | 588 | 696.3 | 119% |
| C | 596 | 541.6 | 93% |
| D | 591 | 694.3 | 119% |
| E | 582 | 687.2 | 118% |
| f | 589 | 583.9 | 100% |
| G | 592 | 580.0 | 99% |
| H | 594 | 474.8 | 81% |

As can be seen from the grinding tests in Tables 2-4, no performance increase is achieved with Examples D and E compared to Comparative Example B. Rather, the product optimization consists in the fact that with the selection made, the ratio and the amounts of stabilizers, the proportion of inexpensive zircon sand in the raw material mixture can be increased compared to the prior art (Comparative Example B) without there being any loss of performance. Inexpensive zircon sand partly replaces the expensive and scarce raw material baddeleyite or the artificial ZrO₂ concentrates. The cost savings are approx. 30% in relation to the raw materials baddeleyite and zircon sand and approx. 8 to 10% in relation to the finished product (abrasive grains), which means an enormous competitive advantage in view of the highly competitive abrasives market.

1. Abrasive grains based on Al₂O₃ and ZrO₂ that have been melted in an electrical arc furnace and have a content of
Al₂O₃ between 52% and 62% by weight,
ZrO₂ (+HfO₂) between 35.0% and 45.0% by weight, where a total of at least 80% by weight of the ZrO₂, based on the total content of ZrO₂, is in the tetragonal and/or cubic high-temperature modification,
carbon between 0.03% and 0.5% by weight,
reduced titanium oxide, expressed as TiO₂, between 1.0% and 4.0% by weight,
Y₂O₃ between 0.2% and 1.5% by weight,
Si compounds, expressed as SiO₂, of more than 0.8% by weight,
raw material-related impurities of less than 3% by weight,
characterized in that
the raw material base for the abrasive grains comprises aluminum oxide, baddeleyite and zircon sand, the ratio of baddeleyite to zircon sand being 3:1 to 1:2.

2. The abrasive grains according to claim 1,
characterized in that
the raw material base for the abrasive grains comprises aluminum oxide, baddeleyite and zircon sand, the ratio of baddeleyite to zircon sand being from 1.5:1 to 1:1.5.

3. The abrasive grains according to claim 1 or 2,
characterized in that
the proportion of Si compounds in the abrasive grains, expressed as SiO₂, is more than 1.0% by weight.

4. The abrasive grains according to claim 3,
characterized in that
the proportion of Si compounds in the abrasive grains, expressed as SiO₂, is 1.1% to 1.5% by weight.

5. The abrasive grains according to any one of claims 1 to 4,
characterized in that
the ratio of TiO₂ to Y₂O₃ is 2:1 to 6:1.

6. A method for the production of abrasive grains according to any one of claims 1 to 5, comprising the steps of:
mixing the starting materials for abrasive grains with a content of
a) Al₂O₃ between 52% and 62% by weight,
b) ZrO₂ (+HfO₂) between 35.0% and 45.0% by weight, wherein
a total of at least 80% by weight of the ZrO₂, based on the total content of ZrO₂, is in the tetragonal and/or cubic high-temperature modification,
c) Si compounds, expressed as SiO₂, of more than 0.8% by weight,
d) carbon between 0.03 and 0.5% by weight,
e) reduced titanium oxide, expressed as TiO₂, between 1.0% and 4.0% by weight,
f) Y₂O₃ between 0.2 and 1.5% by weight, the ratio of TiO₂ to Y₂O₃ being from 2:1 to 6:1, and
g) raw material-related impurities of less than 3% by weight,
melting the mixture in an electrical arc furnace,
quenching the molten mixture to obtain a solid product, and
crushing of the solid product and subsequent sieving to obtain abrasive grains,
characterized in that
the raw material basis for the abrasive grains comprises aluminum oxide, baddeleyite and zircon sand, the ratio of baddeleyite to zircon sand being 3:1 to 1:2.

7. The method according to claim 6,
characterized in that
the ratio of baddeleyite to zircon sand is 1.5:1 to 1:1.5.
